(19) United States
(12) Patent Application Publication
(10) Pub. No.: US 2008/0115099 A1
(43) Pub. Date: May 15, 2008

(54) Spatial curvature for multiple objective routing

(76) Inventor: Priyadarsan Patra, Portland, OR (US)

Correspondence Address: LEE & HAYES, PLLC, P.O. BOX 52050, MINNEAPOLIS, MN, 55402, US

(21) Appl. No.: 11/599,675

(22) Filed: Nov. 15, 2006

(51) Int. Cl. G06F 17/50

(52) U.S. Cl. 716/13; 716/12

(57) ABSTRACT

Spatial curvature techniques for multiple objective routing is described. In one or more embodiments, routing between components of an integrated circuit may be determined by transforming pin configurations (e.g., nets) associated with the integrated circuit into a curved space which accounts for multiple design objectives as geometric distance. In the transformed space one or more routings may be computed for a [in configuration to meet one or more specified criteria.

### BACKGROUND

The layout process of integrated circuits is traditionally divided into the placement phase and the routing phases for complexity reasons. Placement refers to determining the locations for the various components of the integrated circuit. Routing is the process of wiring together each set of electrically equivalent pins, called a net, that belong to the components (e.g., devices, cells, macro-blocks and so forth) in the layout of a very large scale integrated (VLSI) design. In the routing phase, determination of a routing configuration of a net may depend upon multiple objectives including cost, wire length, timing, power, congestion and so forth.

Traditional techniques to determine global routing are typically limited to minimizing overall route length alone or to minimizing the overall route length separately from other performance metrics such as timing, power, congestion and so forth. Therefore, these traditional techniques focused on overall route length and consequently neglected other objectives and techniques, which may result in suboptimal optimization of different performance metrics.

### BRIEF DESCRIPTION OF THE DRAWINGS

FIG. 1 illustrates an exemplary implementation of a system in which spatial curvature techniques for multiple objective routing may be employed

FIGS. 2A to 2C illustrate an exemplary implementation of spatial curvature techniques in accordance with one or more embodiments.

FIG. 3 is a flow diagram of a procedure in an exemplary implementation in which spatial curvature techniques are employed for multiple objective routing.

FIG. 4 is a flow diagram of a procedure in an exemplary implementation in which pre-computed net topologies are utilized to determine a routing for a pin configuration in curved space.

FIG. 5 depicts an exemplary implementation of a configuration graph which may be utilized to pre-compute net topologies.

FIG. 6 depicts an exemplary implementation of an abstract topology which may represent a plurality of concrete net topologies.

### DETAILED DESCRIPTION

In the embodiments below, spatial curvature techniques for multiple objective routing is described in which routing may be determined between components of an integrated circuit. In at least some embodiments, this is accomplished by transforming pin configurations (e.g., nets) associated with the integrated circuit into a curved space which accounts for multiple design objectives as geometric distance and in the transformed curved space, computing a routing. The computed routing is then translated to “normal space” to obtain a routing for the given pin configuration. As will be appreciated by one skilled in the art and in view of the discussion below, this may result in improved performance, faster determination of routing, and lower costs.

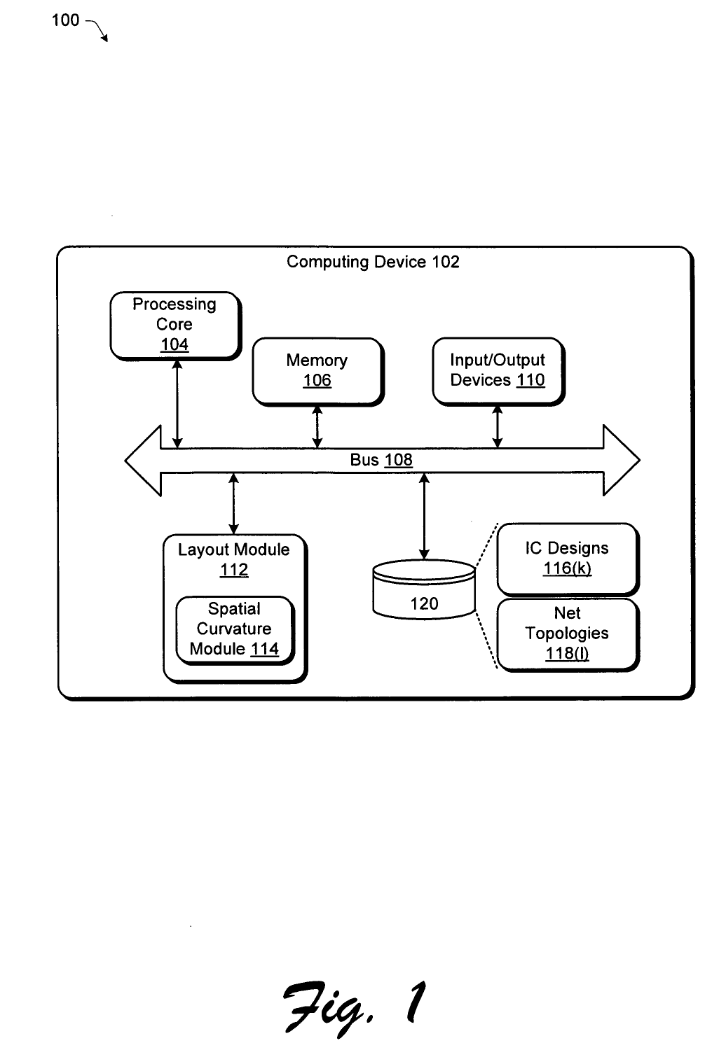

FIG. 1 illustrates, generally at 100, an exemplary system in which the described spatial curvature techniques may be implemented in accordance with one or more embodiments. System 100 includes, in this example, computing device 102, which in turn includes at least one processing core 104 (which may include processing components and related memory systems), a memory 106, and a interconnect 108 which may communicatively couple the components of the computing device. The computing device 102 may be configured in a variety of ways including but not limited to a desktop or portable computer, a laptop, handheld computers such as personal digital assistants (PDAs), or other computing devices suitable to perform spatial curvature. Processing core 104 is capable of communicating with various components of computing device 102 (some of which are not illustrated here). Memory 106 may be configured in a variety of ways such as a “main memory” of system 100, dynamic random access memory (DRAM), hard disk memory, flash memory, and so forth. In an embodiment memory 106 may be an integrated portion of processor core 104. Interconnect 108 may be configured as a system bus or otherwise configured to interconnect components in the system 100.

System 100 may also include a variety of input/output devices 110. The input/output devices 110 for example may include one or more of a display, a camera, a cursor control device (e.g., mouse, arrow buttons, stylus and so forth), a keyboard, speakers, communication ports, as well as other devices configured for input/output of information via computing device 102 and/or system 100.

FIG. 1 further depicts a layout module 112 which represents functionality at least to determine routings between components of an integrated circuit. Additional functionality provided by a layout module 112 may include but is not limited to integrated circuit (IC) design, placement of components for an IC, division of an IC into discrete blocks and nets for analysis, determination of global routing for nets and associated ICs, optimization tools for an IC design and so forth. In an embodiment, the layout module 112 may be provided as an integrated portion of a Computer Aided Design (CAD) package for the design and/or layout of ICs. In other words, the layout module 112 may be configured to design where components of ICs are located and the interconnection of those components (e.g., the routing for the IC). In an embodiment, the layout module 112 includes a spatial curvature module 114 which represents functionality to utilize spatial curvature techniques described herein to compute routings for ICs. Naturally, the spatial curvature module 114 may be provided with the layout module 112, as a stand alone module, and so forth.

In operation, computing device 102 may execute the layout module 112 and/or spatial curvature module 114 to produce one or more integrated circuit designs 116(k) where “k” may be any integer. Further, the layout module 112 and/or spatial curvature module 114 may operate to pre-compute and/or store one or more net topologies 118(1), which provide predetermined layouts and/or routing options for particular arrangements of pins, e.g. pin configurations. These net topologies 118(1) may be pre-stored and referenced or “looked-up” in the determination of a layout for an IC. This pre-computation and “look-up” may reduce the time required to produce an IC layout design compared computing the net topologies 118(1) at run-time. In an embodiment, the computing device 102 may include a database 120 which is configured to store the integrated circuit designs 116(k) and/or net topologies 118(1) as well as other data for the design of ICs. The database may be maintained in memory 106 or other suitable storage. Further description of IC layout utilizing spatial curvature techniques may be found in reference to the following figures.

Processors are not limited by the materials from which they are formed or the processing mechanisms employed therein. For example, processor 104 may be comprised of semiconductor(s), transistors (e.g., electronic integrated circuits (ICs)), and/or a variety of other mechanisms. In such a context, processor-executable instructions may be electronically-executable instructions. For example, the processor 104 may execute one or more modules in response to inputs received from one or more input/output devices 110.

Generally, any of the functions described herein can be implemented using software, firmware, hardware (e.g., fixed logic circuitry), manual processing, or a combination of these implementations. The terms “module,” “functionality,” and “logic” as used herein generally represent software, hardware, firmware, or a combination of software, hardware, and firmware. In the case of a software implementation, the module, functionality, or logic represents program code that performs specified tasks when executed on a processor (e.g., processor core 104). The program code can be stored in one or more computer readable memory devices, one example of which is memory 106. Thus, for example, the layout module 112 and/or spatial curvature module 114 may be implemented as software and as such may be storable in memory 106 or other suitable memory, and may also be executed via processor core 104, or other suitable processing components. The features of the spatial curvature techniques described herein are platform-independent, meaning that the techniques may be implemented on a variety of commercial computing platforms having a variety of processors.

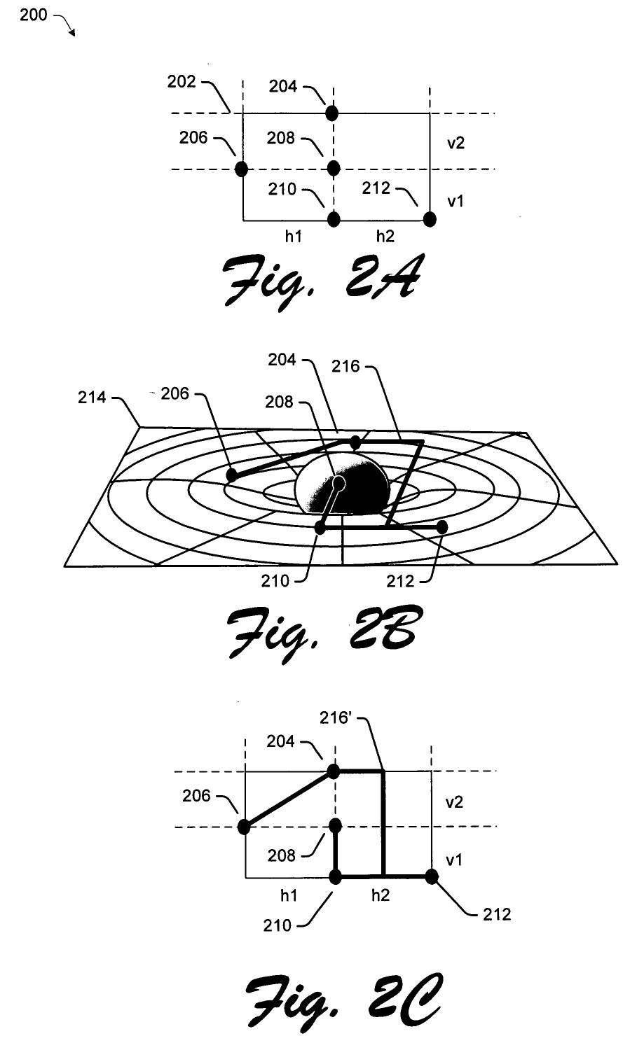

FIGS. 2A-2C illustrate conceptually spatial curvature techniques applied to a net which may correspond to an IC and or a portion thereof. Those of skill in the art will appreciate that the layout process of integrated circuits is traditionally divided into the placement phase and the routing phases. Routing is the process of wiring together each set of electrically equivalent pins, called a net, belonging to the components (devices, cells, macro-blocks and so forth) in the layout of a very large scale integration (VLSI) design. For instance, the layout module 112 described in FIG. 1 may divide a circuit design into a plurality of individual nets, each of which includes a plurality of pins. Each net of an IC has a corresponding pin configuration (PC), e.g. the arrangement of the pins.

FIG. 2A depicts an exemplary implementation 200 of a Hanan grid 202 which may correspond to one net of an IC. As those of skill in the art will appreciate, a Hanan grid is formed by connecting the pins of a net by horizontal and vertical lines to form a grid which represents the relative positions of the pins in the net. In FIG. 2A a plurality of pins 204, 206, 208, 210 and 212 are depicted which are arranged in a particular pin configuration (PC). The Hanan grid has horizontal segments and vertical segments which may be used as a coordinate system to describe the pin locations and routing between the pins.

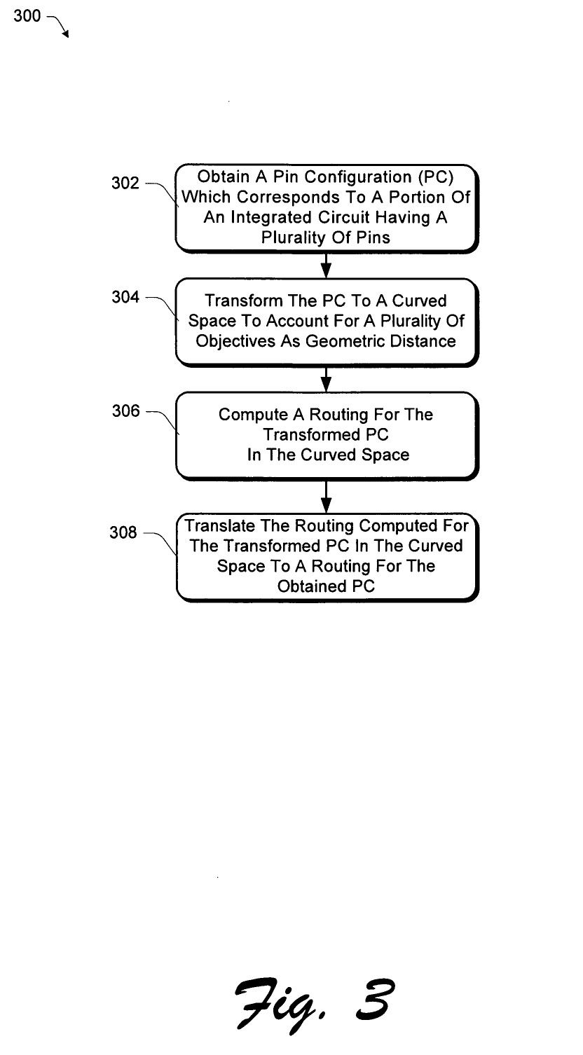

In FIG. 2B, the multiple objectives for design of an IC (e.g., sink required times loads, and so forth) are accounted for as geometric space equivalents to get a curved space 214. For instance, the spatial curvature module 114 of FIG. 1 may be executed by processing core 104 to compute a function of the multiple design objectives, such as relative required times, loads, physical distances and driver strength, which account for the multiple objectives as distance equivalents. In other words, multiple objectives are transformed into geometric distance equivalents which virtually stretch the space to achieve a virtual or curved space 214 as represented in FIG. 2B. The pin locations for an IC design may be fixed by the placement phase of a layout, thus the additional path length between pins resulting from consideration of the multiple objectives may create a curved space 214 which accounts for the multiple objectives. Further description of accounting for multiple design objectives in optimization of a net and/or IC layout may be found in relation to FIG. 3.

A routing 216 may then be computed in the curved space 214 for the net. For instance, the path lengths to the critical sinks may then be minimized by minimizing the wire lengths in the curved space between the pins. In an embodiment, the determination of routing 214 may be accomplished via a set of pre-computed routing grids, e.g. the net topologies 118(1) of FIG. 1. The routing 216 determined in the curved space may then be translated to the Hanan grid 202 of the original PC by matching segments with a virtual Hanan grid in the curved space. Referring to FIG. 2C the Hanan grid 202 in the original space is depicted with a routing 216′ which may be computed by translating the routing 216 which was determined in the curved space. The relative position of pins in the curved space 214 does not change, thus the segments of a virtual Hanan grid in the curved space (not shown in FIG. 2B for clarity) may be mapped one to one with the Hanan grid 202 in the original space. For instance, pins 210 and 212 are arranged such that a segment h2 of the Hanan grid 202 in FIG. 2A runs between the pins. Thus, if routing 216 determined in the curved spaced runs between pins 210 and 212, this portion of routing 216 may be translated by reproducing the segment in the original space to produce the routing 216′. In this manner each portion of the routing 216 of FIG. 2B may be translated to a routing 216′ as depicted in FIG. 2C. This process may be repeated for each of a plurality of nets corresponding to an IC to compute a routing for the IC as a whole. Further description of spatial curvature techniques to determine an IC layout is provided in reference to the following procedures.

### EXEMPLARY PROCEDURES

The following discussion describes spatial curvature techniques that may be implemented utilizing the previously described systems and devices. The procedures are shown as a set of blocks that specify operations performed by one or more devices and are not necessarily limited to the orders shown for performing the operations by the respective blocks. In discussion of the procedures below, reference may be made to the system, devices and techniques as described above with respect to FIGS. 1 and 2A-2C.

FIG. 3 depicts a procedure 300 in an exemplary implementation in which a routing for a pin configuration which accounts for multiple objectives is determined. A pin configuration (PC) is obtained which corresponds to a portion of an integrated circuit having a plurality of pins (block 302). For example, layout module 112 of FIG. 1 may be executed to produce an integrated circuit (IC) design 116(k). In an implementation, the layout module 112 may divide the IC circuit design 116(k) after a placement phase into a plurality of individual nets, each of which includes a plurality of pins. Each net of an IC has a corresponding pin configuration (PC), e.g. the arrangement of the pins. These nets may be represented by a Hanan grid such as Hanan grid 202 described in relation to FIG. 2A. Thus, the individual nets and associated pin configurations corresponding to an IC design may be obtained such that a spatial curvature techniques may be performed in a routing phase, for instance via spatial curvature module 114.

Then, the pin configuration (PC) may be transformed to curved space to account for a plurality of objectives as geometric distance (block 304). In an implementation, the transformed spaced is determined via matrices which account for multiple objectives as added length, e.g. the spatial curvature of the Hanan grid for a pin configuration PC. Spatial curvature module 114 may be executed to perform the transformation of an input pin configuration PC to a curved space. A Hanan grid for the input pin configuration may be represented by a matrix M such as the following equation (Eq. 1):

$$[ \begin{matrix}{P}_{s - {t}_{1}} \\ {P}_{s - {t}_{2}} \\ M \\ {P}_{s - {t}_{i}}\end{matrix} ] = [ \begin{matrix}{m}_{11} & {m}_{12} & Λ & {m}_{1 , j} \\ {m}_{21} & {m}_{22} & Λ & {m}_{2 , j} \\ M & M & O & M \\ {m}_{i , 1} & {m}_{i , 2} & Λ & {m}_{i , j}\end{matrix} ] [ \begin{matrix}{h}_{1} \\ {h}_{2} \\ M \\ {h}_{i} \\ {v}_{1} \\ {v}_{2} \\ M \\ {v}_{j}\end{matrix} ]$$

Where Pₛ₋ₜᵢ stands for the path length between a source pin (e.g. the pin of a net which receives the input signal) and each other pin tᵢ (also referred to as sinks) of the input PC, e.g. the Hanan grid. The hᵢ and vⱼ stand for the horizontal and vertical segment lengths on the input Hanan grid. The subscripted symbols m_{i,j} stand for the elements (i,j) of the matrix M and are determined from the physical positions of the pins on the input Hanan grid. Using computed lengths corresponding to multiple objectives, the segment lengths (h, v) of the Hanan grid may be adjusted to obtain a curved space.

The computed length of multiple objectives may be accounted for as lᵢ according to the following equation (Eq. 2):

$$[ \begin{matrix}{P}_{s - {t}_{1}} + {l}_{1} \\ {P}_{s - {t}_{2}} + {l}_{2} \\ M \\ {P}_{s - {t}_{i}} + {l}_{i}\end{matrix} ] = [ \begin{matrix}{m}_{11} & {m}_{12} & Λ & {m}_{1 , j} \\ {m}_{21} & {m}_{22} & Λ & {m}_{2 , j} \\ M & M & O & M \\ {m}_{i , 1} & {m}_{i , 2} & Λ & {m}_{i , j}\end{matrix} ] [ \begin{matrix}{h}_{1}^{′} \\ {h}_{2}^{′} \\ M \\ {h}_{i}^{′} \\ {v}_{1}^{′} \\ {v}_{2}^{′} \\ M \\ {v}_{j}^{ ′}\end{matrix} ] ⇒ [ \begin{matrix}{l}_{1} \\ {l}_{2} \\ M \\ {l}_{i}\end{matrix} ] = [ \begin{matrix}{m}_{11} & {m}_{12} & Λ & {m}_{1 , j} \\ {m}_{21} & {m}_{22} & Λ & {m}_{2 , j} \\ M & M & O & M \\ {m}_{i , 1} & {m}_{i , 2} & Λ & {m}_{i , j}\end{matrix} ] [ \begin{matrix}{h}_{1}^{′} - {h}_{1} \\ {h}_{2}^{′} - {h}_{2} \\ M \\ {h}_{i}^{′} - {h}_{i} \\ {v}_{1}^{′} - {v}_{1} \\ {v}_{2}^{′} - {v}_{2} \\ M \\ {v}_{j}^{ ′} - {v}_{j}\end{matrix} ]$$

Thus, virtual “curved space” value for each segment h′ᵢ and v!ᵢ is dependent on the path length Pₛ₋ₜᵢ plus the additional computed lengths lᵢ. From the input Hanan grid and the Eq. 1 above, the values of mᵢⱼ and hᵢ, vⱼ may be known and the additional computed length lᵢ may also be known. In an embodiment, the matrices as depicted above in Eq. 2 may be used to compute curved space values of h′ᵢ and v′ⱼ. Thus, a virtual Hanan Gird in curved space may be computed and/or which has a corresponding virtual pin configuration.

Eq. 2 may have numerous solutions, and may be complex as well as time consuming to solve. Thus, in one or more alternate embodiment a simplification to Eq. 2 may be applied to reduce the complexity. The horizontal and vertical dimensions are separated by dividing the extra wire lengths lᵢ into horizontal and vertical components proportionally. For example, the proportions may be represented as aₙ, bₙ where aₙ+bₙ=1. This gives the following (Eqs. 3):

$$[ \begin{matrix}{a}_{1} {l}_{1} \\ {a}_{2} {l}_{2} \\ M \\ {a}_{n} {l}_{n}\end{matrix} ] = [ \begin{matrix}{m}_{11} & {m}_{12} & Λ & {m}_{1 , n} \\ {m}_{21} & {m}_{22} & Λ & {m}_{2 , n} \\ M & M & O & M \\ {m}_{i , 1} & {m}_{i , 2} & Λ & {m}_{i , n}\end{matrix} ] [ \begin{matrix}{h}_{1}^{′} - {h}_{1} \\ {h}_{2}^{′} - {h}_{2} \\ M \\ {h}_{i}^{′} - {h}_{i}\end{matrix} ] and [ \begin{matrix}{b}_{1} {l}_{1} \\ {b}_{2} {l}_{2} \\ M \\ {b}_{n} {l}_{n}\end{matrix} ] = [ \begin{matrix}{m}_{1 , n + 1} & {m}_{1 , n + 1} & Λ & {m}_{1 , j} \\ {m}_{2 , n + 2} & {m}_{2 , n + 2} & Λ & {m}_{2 , j} \\ M & M & O & M \\ {m}_{n , n + 1} & {m}_{n , n + 2} & Λ & {m}_{i , j}\end{matrix} ] [ \begin{matrix}{v}_{1}^{′} - {v}_{1} \\ {v}_{2}^{′} - {v}_{2} \\ M \\ {v}_{j}^{ ′} - {v}_{j}\end{matrix} ]$$

These equations may have feasible and unique solutions, and which may be solved to compute the virtual Hanan grid positions in the curved space (e.g., the values for segments h′ᵢ and v′ⱼ). For example, the ratio of the horizontal and vertical wire lengths may be determined and used to compute a virtual PC as represented in FIG. 2B and a corresponding Hanan grid. This simplification may speed up the computation of the curved space PC positions without unacceptable effects on accuracy. The result is a transformed PC (e.g., transformed pin positions) which may be represented by a corresponding virtual Hanan grid which has adjusted values h′ᵢ, v′ⱼ for the segments

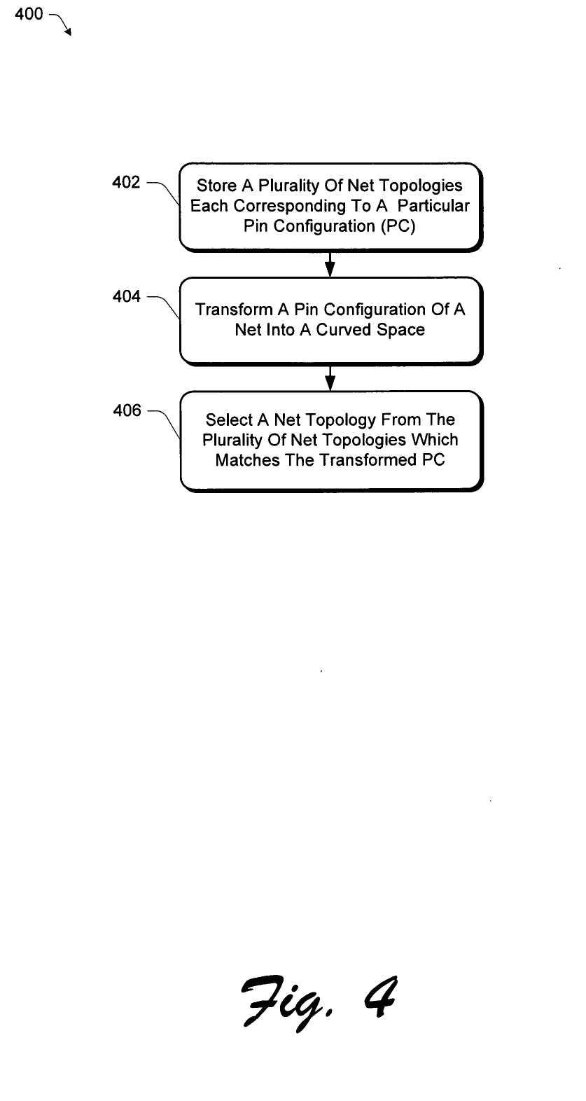

A routing is calculated for the transformed PC in the curved space (block 306). For instance a routing 216 as depicted in FIG. 2B may be determined for a computed PC. This routing 216 may be computed according to one or more optimization criteria applied to the transformed PC, such as minimizing length of the routing traces, worst case negative slack (WNS), total negative slack (TNS), all arc total negative slack and so forth. Further, the routing 216 may be the result of applying one or more pre-computed net topologies, such as net topologies 118(1) depicted in storage 120 of FIG. 1. Techniques for pre-computing and storing net topologies are further described with reference to FIG. 4-6 below.

The routing computed for the transformed PC in the curved space is translated to a routing for the obtained PC (block 308). In an embodiment, the translation may involve a one to one mapping of segments of a routing, such as routing 216 of FIG. 2B, from a Hanan grid in the curved space, to a Hanan grid in the original space, to obtain a routing 216′ for the original pin configuration. Naturally, due to the applied spatial curvature techniques, the segment lengths may shrink or stretch during the translation. In this manner, the resultant routing 216′ may be optimized for multiple objectives which are accounted for as geometric distance in the curved space.

It is noted that the spatial curvature techniques described may be applied to variety of multiple objective some examples of which are, relative required time (RRT), congestion, power, loads, driver strength and so forth. These and other objectives may be accounted for as geometric distance, in other words as portions of the additional computed length lᵢ in the matrices described above. Since the pin configuration (e.g., the location of the sinks) may be predetermined for the physical layout of an IC, the actual location of the pins is not moved, rather the additional length lᵢ is considered to curve the space to allow for the added length, hence the spatial curvature. Descriptions of converting a few of the contemplated multiple objectives to distance equivalents are provided below by way of example and are not intended to limit the multiple objectives to the examples provided.

For example, relative required times may be expressed as distance equivalents in the curved space. Required time is the required time at a sink (the sink being the component/device located at a particular pin location) assuming the signal arrives at the source (the source corresponds to the pin at which the signal arrives into the net) at time=0. The relative required time (RRTi) of a sink (e.g., the sinks correspond to the pin locations) which is the required time difference between every sink and the sink with the maximal required time may be computed as:

$${RRT}_{i} = {max}_{j ∈ sin ks} ( {RT}_{j} ) - {RT}_{i}$$

For example, given two sinks A and B having respective required times of 10 picoseconds (ps) and 15 ps before latching clock, then the RRT_{A}=0 ps and RRT_{B}=5 ps, e.g. sink B has a required time that is 5 ps greater than for sink A. The RRTᵢ may then be considered as the delay introduced by some extra wire length on the source-sink paths. The Elmore Delay model may be used to get these extra wire lengths one formulation of which may be expressed as follows:

$${D}_{i} = {r}_{d} ( {C}_{tree} + {\sum }_{j ∈ pins} {Cload}_{j} ) + {\sum }_{k ∈ tree edges} {R}_{k} {C}_{k}$$

$${D}_{i}^{′} = {r}_{d} ( {C}_{tree} + {\sum }_{j ∈ pins} {Cload}_{j} + {c}_{0} {l}_{i} ) + {\sum }_{k ∈ tree edges} {R}_{k} ( {C}_{k} + {c}_{0} {l}_{i} ) + \frac{1}{2} {r}_{0} {l}_{i} \cdot {c}_{0} {l}_{i} {Cloud}_{i}$$

$$Δ {D}_{i} = {r}_{d} {c}_{0} {l}_{i} + {\sum }_{k ∈ tree edges} {R}_{k} {c}_{0} {l}_{i} + \frac{1}{2} {r}_{0} {l}_{i} \cdot {c}_{0} {l}_{i} {Cloud}_{i} = {RRT}_{i}$$

Where, R is resistance, C is capacitance, Dᵢ is delay without extra length and D′ᵢ is the delay with the added length lᵢ. The change in delay (ΔDᵢ) may then be equated to the RRTᵢ from which the extra length lᵢ may be computed. This length lᵢ may then be incorporated into the spatial curvature matrices previously described to account for relative required time difference of respective sinks.

Congestion is another one of the multiple objectives which may be accounted for as geometric distance. Congestion refers to the number of routes through an edge or in an area and so forth relative to the available capacity. In an embodiment, a global congestion map may be used which indicates the relative congestion of each region or net of an IC design. An assigned value or a weighting factor may be given to each net and/or subnet (a subnet is a portion of a net) based on the global congestion map. For example, one net or subnet may be assigned a value of 1 and a relatively more congested net a value of 1.2. A variety of different weighting scales are contemplated. These weighting factors may be used to adjust the lengths lᵢ values accordingly to account for congestion. In this manner, areas of higher congestion areas (e.g. having may pins and/or cells) would cause more stretching in the spatial curvature which would discourage multiple route trees segments from passing through the congested area.

Similar techniques may be employed to account for loads, driver strength, power, as well as other multiple objectives as distance equivalents for the spatial curvature matrices. For example, the loads for each sink/pin in a net may be considered as delay e.g., loads may be accounted for as capacitance in the Elmore delay formulation. Similarly, driver strength, the strength of the incoming signal may also be accounted for as delay in the Elmore delay model as resistance. Then, per the Elmore delay described above these multiple objectives may be converted to lᵢ equivalents similar to the computation described for RRTᵢ. Spatial curvature techniques may employ a variety of other conversions of multiple objectives to length equivalents without departing from the sprit and scope thereof. Thus, lᵢ may be computed for each pin of an input pin configuration which incorporates multiple objectives as geometric distance. These lᵢ values may be input to the described matrices to produce a transformed pin configuration, and to obtain a routing for the transformed pin configuration.

FIG. 4 depicts a procedure 400 in an exemplary implementation in which pre-computed net topologies are utilized to select a routing for a pin configuration in curved space. A set of net topologies are stored each of which corresponds to a routing of the particular pin configuration (PC) (block 402). For instance, 118(1) net topologies of FIG. 1 may include one or more set of potentially optimum topologies (POT) corresponding to a net and/or pin configuration.

A pin configuration of a net is transformed into curved space (block 404). For instance the previously described spatial curvature techniques may be employed to produce a transformed PC which accounts for multiple objectives as geometric distance. Then in the curved space, distance minimization techniques are used and the transformed PC is utilized to optimize the routing of the net.

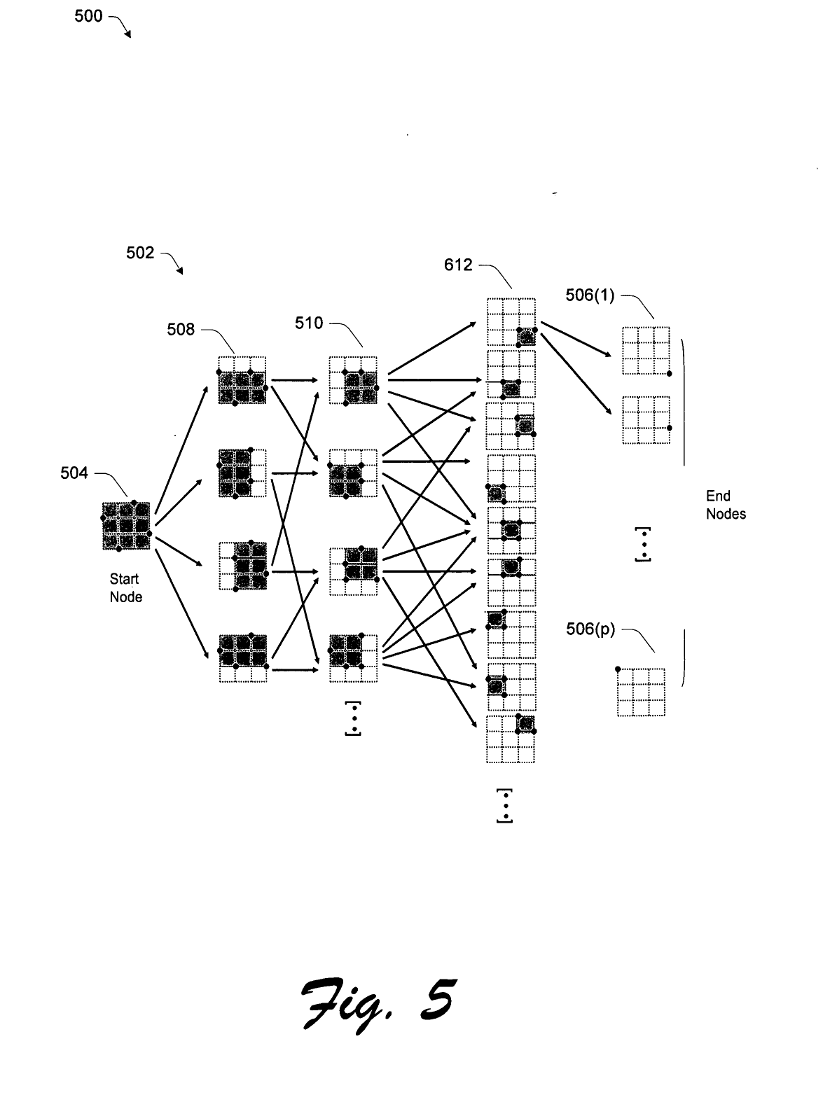

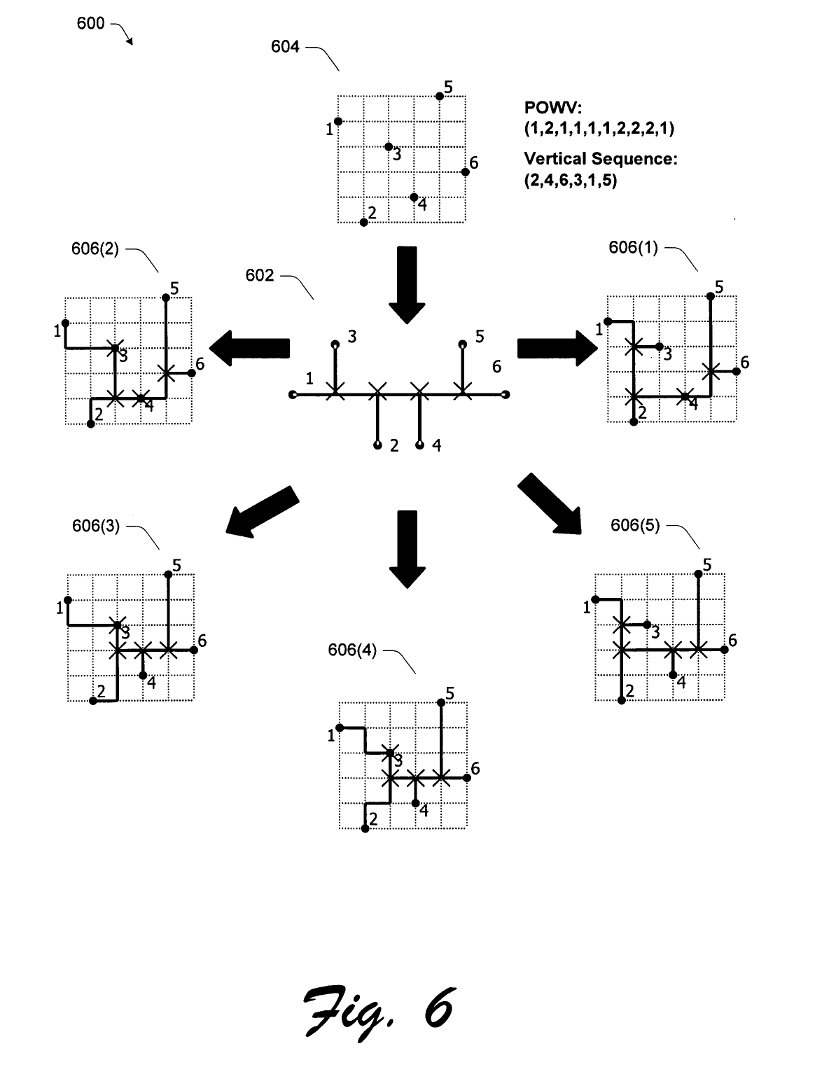

A net topology is selected from the stored set which matches the transformed PC (block 406.). For instance, a pre-computed table of topologies for nets may be stored, such as net topologies 118(1) of FIG. 1. These pre-computed net topologies 118(1) may be determined in a variety of ways, one or more examples of which are discussed with respect to FIG. 5-6. These net topologies 118(k) may be referenced at run-time to select an optimum routing for an input net. The optimization of the routing may be according to one or more criteria such as minimizing length of the routing traces, worst case negative slack (WNS), total negative slack (TNS), all arc total negative slack and so forth. Repeating the individual routing selection for numerous nets of an IC design may allow a routing for the whole IC to be computed quickly. Thus, pre-computation may optionally be used to improve run-time efficiency. For instance, the partial pre-computation of a routing through pre-computed/pre-stored net topologies 118(k) may speed up the routing by 5 to 10 times compared to full calculation at run-time. As net size increase, the additional computation may erode the performance gains. Thus, in an embodiment for large nets having greater than about 12 pins, net-breaking heuristics to break the large net into sub-nets (smaller components with about 12 or fewer pins) may be utilized. The spatial curvature techniques may then be applied to the individual sub-nets.

FIG. 5 depicts an exemplary implementation 500 of a configuration graph 502 which may be generated using boundary compaction and used to pre-compute net topologies. While the following describes configuration graphs for pre-computation of net topologies, other suitable techniques to pre-compute and pre-store net topologies may alternatively be used without departing from the spirit and scope thereof.

Consider a net having d pins, e.g. a d-pin net where d defines the degree of the net. One traditional technique indicates that the set of all degree nets can be partitioned into d! groups according to their relative pin positions. The relative position of the pins defines a vertical sequence. If sᵢ is the rank of pin i, the vertical sequence may be written as s₁s₂ . . . s_{d}. For each such group corresponding to a vertical sequence, the wire length of possible routing topologies along the Hanan grid can be written as a small number of linear combinations of distances between adjacent Hanan grid lines. These linear combinations may each be expressed as a vector of the coefficients in the Hanan grid which is called a wirelength vector (WV). For example, a WV corresponding to a two by two Hanan grid as in FIG. 2A may be (1, 1, 2, 1) which corresponds to a wirelength of h1+h2+2v1+v2, where h1, h2, v1 and v2 are the horizontal and vertical segment lengths of the Hanan grid. A potentially optimum wirelength vector (POWV) is one in which the sum of the coefficients in minimal and thus may produce the minimal wirelength. For instance, a WV (1,1,1,1) is a POWV for the Hanan grid in FIG. 2A, however, the WV (1,1,2,1) is not a POWV since it will be a value of v1 greater than WV (1,1,1,1).

In an implementation, an entire set of topologies corresponding to each POWV for a pins configuration are encoded and efficiently stored using a configuration graph. In this way, each topology corresponding to a POWV may be considered as a candidate routing for an input pin configuration, such as a PC formed using spatial curvature techniques. Further, the selection of a routing may be based on criteria other than reduction of wirelength, such as routing blockages and the selection criteria may be varied for the same and/or different nets.

In an embodiment, boundary compaction techniques are employed to produce a configuration graph and intelligently select a desired set of topologies which are potentially optimum topologies (POTs). As those of skill in the art will appreciate, a boundary compaction reduces the Hanan grid size by compacting one of the four boundaries, e.g., shifting all pins on a boundary to the grid line adjacent to that boundary.

A configuration graph for a given group (vertical sequence) may be generated from the original PC or start node 504. In a configuration graph, every node (e.g., each of the individual grids) corresponds to a PC. These nodes of a configuration graph 502 may be referred to as configuration nodes (CN). There are two kinds of special nodes in the configuration graph. One is the CN corresponding to the original PC for a vertical sequence which is referred to as the start node 504 because a boundary compaction operation starts with it. The other type is the CN with the PC in which all the pins are compacted to a single point on the grid, which are referred to as end nodes, such because a compacting sequence ends with such a CN. Configuration graph 502 is depicted having a plurality of end nodes 506(1), [ . . . ], 506(p). When boundary compaction is applied to a CN, a new CN with a new corresponding PC is generated. The new CN has no pin on the compacted boundary and may have the same or less pins than the original CN because some pins may collapse together.

In an embodiment, to produce the configuration graph 502 of FIG. 5 the four boundaries of the original PC (start node 504) are compacted to get four new CNs. For instance, column 508 in FIG. 5 having four CNs is the result of compaction performed on the start node 504. Similarly, boundary compaction may be recursively applied on CNs created from a previous boundary compaction. For instance CNs from column 508 may be compacted to generate the plurality of CNs in column 510, which may be further compacted to produce the CNs of column 512, and so on. A compacting sequence is defined as a sequence of compaction operations that reduces the start node 504 (e.g., the original PC grid) to an end node 506(p) e.g., a PC having a single pin. Each compacting sequence corresponds to a possible routing or net topology between the start node 504 and an end node 506(p). Although the number of possible compacting sequences for a particular original PC may be large, many of the compacting sequences are redundant and may be pruned away, e.g., eliminated.

In an implementation, partial wirelength vectors (PWVs) may be used to prune redundant compacting sequences. A PWV is a wirelength vector (WV) with undecided entries obtained after a sequence of compactions. For example, if a full WV is (1221,1121), a PWV could be (1xx1,11x1) (where x means undecided). The undecided part corresponds to the horizontal edges or vertical edges that have not been created by boundary compaction. For each CN in a configuration graph 502, a set of PWVs are associated with it. They are the PWVs corresponding to the edges created by compacting sequences that can result in the PC associated with the CN. If compacting one boundary of the PC associated with a CN can get the PC of another CN, an edge is created from the first CN to the second. The edge refers to the corresponding segment in the Hanan grid along which the pin moves in a boundary compaction. If a PWV at a CN is worse than another, the former cannot be part of any POWV and thus it can be pruned. A PWV is considered worse than another if the values for each position are the same or higher than the values of another PWV. For instance, a first PWV (1222, 1121) is worse than a second PWV (1221,1121) because the value in the fourth position is greater in the first PWV than in the second PWV (e.g. 2 vs. 1) and accordingly the overall wirelength of the first PWV cannot be less than the second. The first PWV may be pruned due to the dominant second PWV, e.g. pruned by “PWV dominance”. A variety of other suitable pruning techniques are also contemplated.

It is noted that compacting different CNs can result in the same CN which have different PWVs. Therefore, the PWVs maybe pruned using “PWV dominance” at each CN. In other words, the PWVs which may be POWV are retained and the others are eliminated. Then, the PWVs remaining after pruning associated with a CN will be used to generate further PWVs when compacting this CN to generate new CN in the configuration graph 502. This recursive CN generation will stop when the new generated CN is an end node 506(p), where no compaction can be applied. The result is the full configuration graph 502 for a start node 504.

The corresponding net topologies may be obtained by tracing back along the compacting sequences. A path of edges in a compacting sequence from an end node 506(p) to the start node 504 produces a net topology (i.e., a valid routing topology) and more particularly a POWV. Many of the topologies generated by different compacting sequences may be redundant. There are two kinds of redundancy. First, different compacting sequences may generate the same topology. Second, different compacting sequences generate different but equivalent topologies in terms of both overall wirelength and timing. Two topologies are equivalent when they are the same in all node positions (pins and Steiner nodes) on a Hanan grid and the connections between nodes. The only difference between equivalent topologies is their embeddings for the connections.

In an embodiment, abstract topologies may be used to avoid storing redundant topologies generated by different compacting sequences. An abstract topology for a net is the topology on the Hanan grid that fixes the positions for all the nodes (pins and Steiner nodes) and the connections between these nodes. The difference between an abstract topology and a normal topology on the Hanan grid is that the abstract topology may not specify how the connection is embedded on Hanan grid. If two compacting sequences generate the same topology or equivalent topologies, their corresponding abstract topologies are the same. Therefore, rather than storing topologies individually, the different abstract topologies for the POWVs may be used to compactly represent a plurality of corresponding net topologies.

FIG. 6 depicts an exemplary abstract topology 602 which corresponds to a pin configuration 604 and which may represent a plurality of net topologies, including the depict topologies 606(1) to 606(5). The pin configuration 604 is depicted on an Hanan grid and has a POWV of (1,2,1,1,1,1,2,2,2,1) and a vertical sequence of (2,4,6,3,1,5). Each of the net topologies 606(1) to 606(5) represents a possible routing for the PC 604. Thus, abstract topology 602 may be used to provide a compact representation of the plurality of net topologies. The abstract topology 604 may then be used along with specified criteria (e.g., minimizing length of the routing traces, worst case negative slack (WNS), total negative slack (TNS), all arc total negative slack and so forth) to select one or more routing for an input pin configuration. Further, a particular topology may be selected to works with physical layout constraints, such as routing blockages. Although the concept of abstract topology is very simple, it can save huge amount of table space. For example, consider a 9-pin abstract topology with 7 steiner nodes, 15 two-pin connections. If there are 2 different routings on Hanan grid for 10 two-pin connections of the 15 two-pin connections, the number of embedded topologies=2¹⁰=1024. Thus, using abstract topologies may consume thousands of times less space than directly saving topologies.

Abstract topologies may be determined from the configuration graph such as configuration graph 502 described with respect to FIG. 5. Starting from an end node 506 corresponding to the source pin and for each different POWV, a trace is made back in the reverse direction of edges developed from the compacting sequences on the configuration graph until reaching the start node 504. This back trace will form different paths corresponding to the different compacting sequences. Since each compacting sequence corresponds to a routing or net topology, a variety of topologies for each POWV may be obtained, some of which may be redundant. In an implementation, the different abstract topologies may be directly compared to eliminate redundant topologies, and then the non-redundant topologies may be stored, such as net topologies 118(1) of FIG. 1.

The generation and comparison of a full set of abstract topologies may take a lot of runtime, and accordingly may be expensive from both cost and timing standpoints. Thus, as an alternative to direct comparison of abstract topologies, a topology signature is introduced which may be used to more efficiently determine a set of non-redundant abstract topologies. A topology signature of a Hanan grid topology (for a given pin configuration) is the position of the Steiner nodes in the topology. For topologies generated by boundary compaction, two topologies A and B with the same topology signature will have the same abstract topology. In other words, topology signature is related to abstract topology on a one-to-one basis. Thus, instead of finding each different abstract topology for each POWV, topologies with different topology signatures may be found. For the topologies generated by different compacting sequences from a configuration graph, different topology signatures may be determined by comparing the Steiner node positions on a Hanan grid. Then, for the plurality of different topology signatures, their corresponding abstract topologies may be pre-computed and/or stored in a table, database and so forth. The pre-computed and/or pre-stored abstract topologies may be referenced at run-time to sort out (for e.g., rank, list, classify) and determine a choice of one or more routings for an input pin configuration in combination with the previous spatial curvature techniques.

### CONCLUSION

Although the embodiments have been described in language specific to structural features and/or methodological acts, it is to be understood that the subject matter defined in the appended claims is not necessarily limited to the specific features or acts described. Rather, the specific features and acts are disclosed as exemplary forms of implementing the claimed subject matter.

What is claimed is:

1. A method comprising:
transforming an input pin configuration of an integrated circuit to a curved space to account for a plurality of objectives as geometric distance; and
computing a routing for the transformed pin configuration in the curved space.

2. A method as recited in claim 1, further comprising obtaining the input pin configuration from a design layout for the integrated circuit.

3. A method as recited in claim 1, wherein transforming the input pin configuration to a curved space includes determining an adjusted size for one or more segments of a Hanan grid corresponding to the input pin configuration.

4. A method as recited in claim 1, wherein the plurality of objectives are accounted for as geometric distance, at least in part, by determining one or more adjusted length values based upon the plurality of objectives.

5. A method as recited in claim 4, wherein the one or more adjusted length values form a transformed Hanan grid corresponding to the input pin configuration.

6. A method as recited in claim 5, wherein the one or more adjusted length values are to be input into a matrix to calculate an adjusted size for one or more segments of a Hanan grid corresponding to the input pin configuration to determine the transformed Hanan grid.

7. A method as recited in claim 1 wherein the plurality of objectives are selected from a group consisting of wirelength, relative required times, power, driver strength, loads, and congestion.

8. A method as recited in claim 1 wherein the computation of the routing includes selecting one or more criteria to optimize the routing in the curved space.

9. A method as recited in claim 7 wherein the one or more criteria are selected from the group consisting of overall wirelength, worst case negative slack, total negative slack, routing blockages, and all arc total negative slack.

10. A method as recited in claim 1, wherein the routing is computed to minimize the length in the curved space of routing traces between a plurality of pins of the input pin configuration.

11. A method as recited in claim 1 wherein computing a routing includes referencing one or more pre-stored net topologies.

12. A method as recited in claim 1, wherein:
the pin configuration defines positions for a plurality of pins; and
the routing is to determine a path for wiring traces between the plurality of pins.

13. A method comprising:
storing a plurality of net topologies each corresponding to a respective arrangement of pins;
transforming an input pin configuration into a curved space; and
selecting a net topology from the plurality of net topologies which matches the transformed pin configuration to determine a routing for the transformed pin configuration.

14. A method as recited in claim 13, wherein at least one of the plurality of net topologies is stored as an abstract topology which provides a compact representation of at least two net topologies.

15. A method as recited in claim 13, wherein at least one of the plurality of net topologies is determined based upon a configuration graph formed from the corresponding arrangement of pins.

16. A method as recited in claim 15 wherein the configuration graph is formed via recursive boundary compaction of the corresponding arrangement of pins.

17. A method as recited in claim 13 wherein, the curved space is determined by calculating an adjusted value for one or more segments of a Hanan grid corresponding to the input pin configuration.

18. One or more computer readable media comprising computer executable instructions which, when executed, direct a computing device to compute a routing for an input pin configuration of a portion of an integrated circuit design that is transformed into a curved space to account for a plurality of objectives as geometric distance.

19. One or more computer readable media as recited in claim 18 further comprising instructions to translate the routing computed for the transformed pin configuration to a routing for the input pin configuration.

20. One or more computer readable media as recited in claim 18, wherein the curved space is determined by calculating an adjusted size for one or more segments of a Hanan grid corresponding to the input pin configuration.

21. One or more computer readable media as recited in claim 18, wherein transformation of the input pin configuration to the curved space includes:
determining one or more adjusted length values based on the plurality of objectives; and
based upon the one or more adjusted length values, calculating corresponding adjustments to the size of one or more segments of a Hanan grid for the pin configuration.

22. A system comprising;
a processor core;
a cursor control device operable to provide inputs which cause the processor core to execute one or more modules; and
at least one said module executable to:
transform an input pin configuration corresponding to a portion of an integrated circuit to a curved space to account for a plurality of objectives as geometric distance; and
compute a routing for the input pin configuration by minimizing length of routing traces between a plurality of pins of the pin configuration in the transformed space.

23. A system as recited in claim 23 wherein the module is executable to translate the routing computed in the transformed space to a routing for the input pin configuration.

24. A system as recited in claim 23 wherein the module is executable to reference one or more pre-computed net topologies to compute the routing for the input pin configuration.
